(19) United States
(12) Patent Application Publication
(10) Pub. No.: US 2006/0242044 A1
(43) Pub. Date: Oct. 26, 2006

(54) Checkless funds disbursement systems and methods

(75) Inventors: Todd M. Binet, Houston, TX (US); Jeffery B. Keith, Richmond, TX (US)

Correspondence Address: THOMPSON & KNIGHT, L.L.P.;PATENT PROSECUTION GROUP, 1700 PACIFIC AVENUE, SUITE 3300, DALLAS, TX, 75201, US

(73) Assignee: BVIG Financial, LLC, Houston, TX (US)

(21) Appl. No.: 11/114,948

(22) Filed: Apr. 25, 2005

(51) Int. Cl. G06Q 40/00; G06Q 99/00; H04L 9/00; H04K 1/00

(52) U.S. Cl. 705/35; 705/64

(57) ABSTRACT

A method of providing checkless disbursement of cash due as a funding from a financial transaction includes receiving at an input terminal on a networked system a request for checkless disbursement of cash due as a funding from a financial transaction, the request including information identifying a customer requesting the cash due. A processing subsystem on the networked system determines whether the disbursement request includes valid information and if the disbursement request includes valid information, making the cash due available for disbursement by an cash dispensing terminal on the networked system.

### FIELD OF INVENTION

The present invention relates to methods, systems and computer program products for providing checkless cash disbursement services related to any disbursement previously performed by check such as a loan or benefit. More particularly, the present invention relates to methods, systems and computer program products for disbursing funds made available from a Refund Anticipation Loan (RAL) and/or Refund Transfer (RT).

### BACKGROUND OF INVENTION

The issuing of checks are common transactions for today's financial institutions, such as entities that originate loans or funds transfers such as tax related Refund Anticipation Loans (RALs) and Refund Transfers (RTs). For example, RALs and RTs have become common transactions that occur during tax season. Typically, RALs and RTs are bank products offered to individuals whose tax returns indicate that they are owed a refund from the federal and/or a state government. A RAL is a loan collateralized by an entity based on an anticipated tax refund. A RT is the transfer of an IRS tax refund less any applicable fees to a taxpayer. An individual interested in receiving a RAL or a RT is merely required to inform the tax preparer that he or she wishes to execute a RAL application or RT request. The executed RAL application or the RT request is forwarded by the tax preparer to a financial institution. Upon approval of a RAL application or a RT request the tax preparer arranges for the issuing of a RAL or RT in the amount of the individual's anticipated refund (less any fees). The RAL or RT is typically issued on a cashier's check located at the tax preparer's office. Once the RAL or RT check is issued, it is given to the taxpayer.

One problem with receiving a RAL or RT check is negotiating such check in exchange for cash dollars. Financial institutions are not required to honor checks that are not issued by their institution. Accordingly, an individual with a RAL or RT check has to either find a location of the financial institution that issued the RAL or RT check or another financial institution that is willing to honor the check. This can be a time consuming and frustrating experience when financial institutions have limited locations coupled with long bank teller lines.

Another problem is that when an individual does find a financial institution willing to honor a RAL or RT check, the customer may be required to deposit the check and then wait several days for the check to clear before they can actually receive cash dollars. This is due to the RAL or RT check having to go to the federal reserve and then back to the financial institution that issued the check for verification that the check is authentic and for the correct amount. This can defeat the purpose of a RAL or RT check, where the individual needs the funds to satisfy an immediate financial need.

Thus, there is a need for methods of providing cash disbursement services, and in particular for methods to fund a RAL or a RT disbursed by a financial institution to a customer in cash dollars. Such methods should immediately provide the RAL or RT recipient with cash in lieu of a check. Additionally, these methods should allow for the verification of the identity of the customer to prevent fraudulent disbursement of the proceeds of a RAL or RT, as well as for settling to the provider of cash after the funds associated with the RAL or RT have been disbursed.

### SUMMARY OF INVENTION

The principles of the present invention are embodied in methods and systems which allow cash funds due from a financial transaction to be disbursed without the need for a check or similar instrument. According to one representative embodiment, a method is disclosed for providing checkless disbursement of cash due as funding from a financial transaction and includes receiving at an input terminal on a networked system a request for checkless disbursement of cash due as funding from a financial transaction, the request including information identifying a customer requesting the cash due. A processing subsystem on the networked system determines whether the disbursement request includes valid information and if the disbursement request includes valid information, making the cash due available for disbursement by a cash dispensing terminal on the networked system.

According to embodiments of the present invention, methods, frameworks, and computer program products are disclosed which provide for an interface for disbursing funds made available for a RAL or RT. These principles are particularly suited for implementing a system that allows for the receipt of cash dollars at a disbursement location from proceeds of a RAL or RT originated by a financial institution. A subsystem at a tax preparation site receives checkless cash disbursement information including, but not limited to, customer information and a bank product disbursement method. The first sub-system transmits the checkless transaction request including, but not limited to, an executed RAL application, RT information and checkless cash disbursement information to a subsystem of a financial institution. Funds are disbursed at a disbursement location based on the type of the checkless transaction request. The financial institution originating the RAL or RT is notified upon disbursement of funds. The need to issue a check for the disbursement of a RAL and RT is completely eliminated.

### BRIEF DESCRIPTION OF DRAWINGS

For a more complete understanding of the present invention, and the advantages thereof, reference is now made to the following descriptions taken in conjunction with the accompanying drawings, in which:

FIG. 1 depicts an exemplary checkless funds distribution system according to the principles of the present invention;

FIG. 2 depicts an exemplary block diagram of a representative point of sale (POS) subsystem suitable for use in the system of FIG. 1;

FIG. 3 depicts an exemplary block diagram of a representative cash dispenser, ATM or other cash dispensing mechanism subsystem suitable for use in the system of FIG. 1;

FIG. 4 depicts an exemplary block diagram of a service provider (SP) subsystem suitable for use in the system of FIG. 1;

FIG. 5 depicts an exemplary block diagram of a subsystem of FIG. 1 which can find application according to an embodiment of the present invention;

FIG. 6 depicts an exemplary flow diagram of a method of providing an interface for cashing checks according to an embodiment of the present invention; and

FIG. 7 depicts an exemplary flow diagram of a method of providing for ATM funds disbursement according to an embodiment of the present invention.

### DETAILED DESCRIPTION OF THE INVENTION

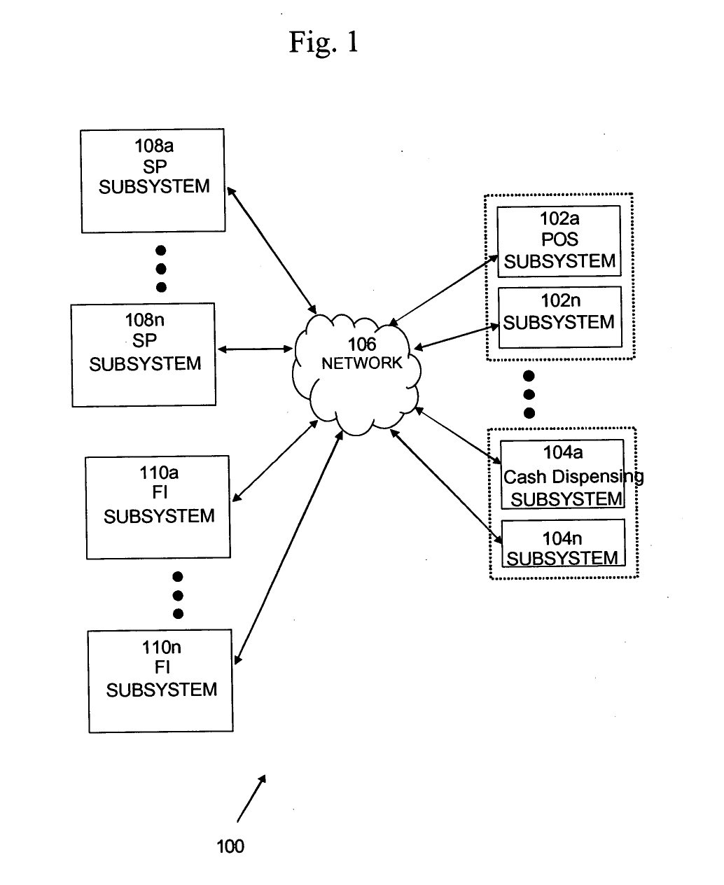

The principles of the present invention and their advantages are best understood by referring to the illustrated embodiment depicted in FIGS. 1-7 of the drawings, in which like numbers designate like parts.

FIG. 1 is an exemplary block diagram of a representative checkless fund disbursement system 100 embodying the principles of the present invention. In particular, in the illustrative embodiment of FIG. 1, system 100 provides an interface for Checkless Fund Disbursement according to the inventive principles. Generally, system 100 supports exchanges of any combination of voice, video and/or data between point of sale (POS) subsystems 102a-102n, cash dispensing subsystems 104a-104n, service provider (SP) subsystems 108a-108n, and financial institution (FI) subsystems 110a-110n over a network 106. Network 106 can be any communications medium over which any combination of voice video and/or data can be transmitted, such as a Wide Area Network (WAN), a Local Area Network (LAN) and/or the Internet.

In the illustrated embodiment of system 100, each subsystem 102 is a Point of Sale (POS) system that includes, for example, a display, input/output device such as a scanner, bar code reader, biometric reader, keypad and/or a receipt printer. POS Subsystems 102, which communicates with SP subsystems 108a-108n and FI subsystems 110a-110n, can receive customer identification information, transmit customer identification information, receive a validation response through network 106, and generate funds disbursement notifications. A given subsystem 102 may be provided, for example, at a tax preparation location or other facility where a loan or transfer may be requested. The point of sale system may be integrated into an existing software and/or hardware solution located at the tax preparation or loan facility.

Each Cash Dispensing subsystem 104 in the illustrated embodiment is a Cash Dispensing Mechanism that includes, for example, a display, input/output device, such as a keypad, biometric reader, a receipt printer and/or a cash dispenser. Cash Dispensing Subsystems 104, which also communicates with SP subsystems 108a-108n and FI subsystems 110a-110n, can transmit a funds disbursement request and receive funds disbursement notifications and dispense cash dollars. A Cash Dispensing subsystem 104 may be paired with a single or multiple POS subsystem 102 within the vicinity of a Disbursement Location site or similar facility where funds may be disbursed as a service.

In the illustrative embodiment of system 100, the type of interface provided between each SP subsystem 108 and each FI subsystem 110 includes, but is not limited to, Active Server Page (ASP) and File Transfer Protocol (FTP) models. Network 106 can also include, for example, a Virtual Private Network (VPN) or Frame circuit which provides a direct link between a given SP subsystem 108 and a given FI subsystem 110. SP subsystem 108 and FI subsystem 110 preferably communicate employing an Active Server Page (ASP) model.

Each SP subsystem 108 in illustrative system 100 can receive checkless disbursement information, disbursement requests, verification responses, including, but not limited to, a verification request, a verification code, time data and date data, process the disbursement transaction information and verification responses, transmit verification requests including, but not limited to, loan or transfer information, customer identification information, and originating clerk identification information, status notification information, funds disbursement notifications and settlement notifications.

In illustrative system 100, each FI subsystem 110 can receive verification requests and settlement notifications, process verification requests, including but not limited to, verifying a segment of transaction information as provided by an SP subsystem 108, flagging the segment of the transaction information as verified, transmit a verification response, and create a settlement file. An FI subsystem 110 may be provided, for example, at a respective location of a financial institution, as well as provided by various financial institutions at a location outside of the financial institutions themselves.

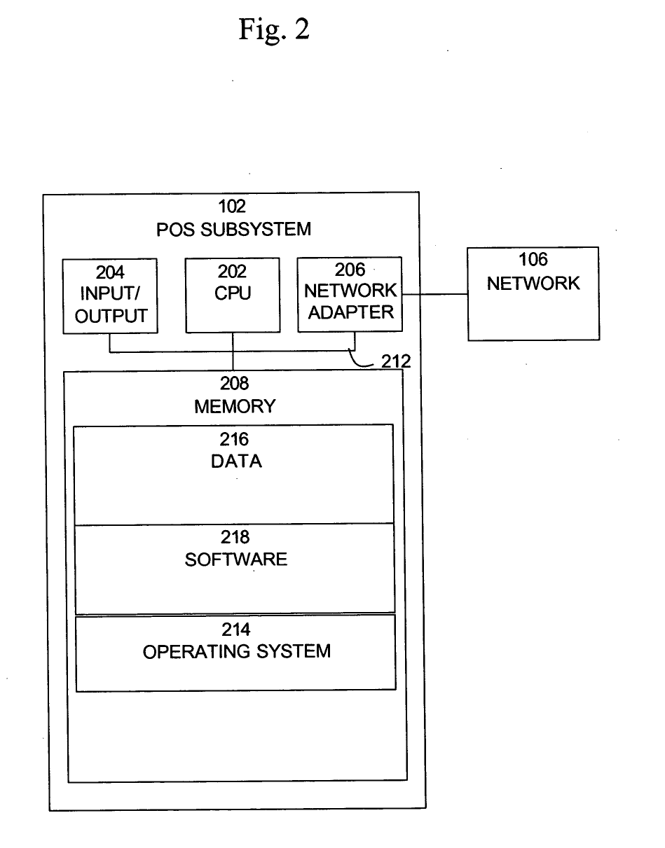

An exemplary block diagram of a representative POS subsystem 102 suitable for use in system 100 of FIG. 1 is shown in FIG. 2. In the illustrative embodiment of FIG. 2, POS subsystem 102 includes input/output device interface and display interface 204, network adapter 206, subsystem memory 208, and CPU 202. CPU 202 is connected by a bus 212 or other suitable interface means to subsystem memory 208, input/output device-display interface 204 and network adapter 206. CPU 202 executes program instructions in order to carry out the functions of the present invention.

Input/output device and display-interface 204 provides the capability to input data to, or output data from POS subsystem 102. For example, input/output device-display interface 204 includes, but is not limited to, input devices such as a readers, keypad, biometric reader, mice, touchpads, trackballs, output devices such as video, monitors, printers, and input/output devices such as dialer/modems. Input/output device and display interface 204 enables input of disbursement method information, customer identification information, and clerk identification information, as well as output of receipts having an disbursement authorization code imprinted thereon. Network adapter 206 interfaces subsystem 102 with network 106.

Subsystem memory 208 stores program instructions that are executed by, and data that are used and processed by, CPU 202 to perform the functions of subsystem 102. Subsystem memory 208 can include electronic memory devices, such as random-access memory (RAM), read-only memory (ROM), programmable read-only memory (PROM), electrically erasable programmable read-only memory (EEPROM), flash memory, and electro-mechanical memory, such as magnetic disk drives, tape drives, optical disk drives, which can use an integrated drive electronics (IDE) interface, or a variation or enhancement thereof, such as enhanced IDE (EIDE) or ultra direct memory access (UDMA), or a small computer subsystem interface (SCSI) based interface, or a variation or enhancement thereof, such as fast-SCSI, wide-SCSI, fast and wide-SCSI, or a fiber channel-arbitrated loop (FC-AL) interface.

In FIG. 2, representative subsystem memory 208 includes operating subsystem 214, data 216 and software 218. Operating subsystem 214 provides overall subsystem functionality. Data 216 can include disbursement information, customer identification information, clerk identification information and disbursement authorization codes. Software 218 provides the functionality for receiving and transmitting information as well as generating receipts. Software 218 may be integrated with other software used in the loan origination or tax preparation process.

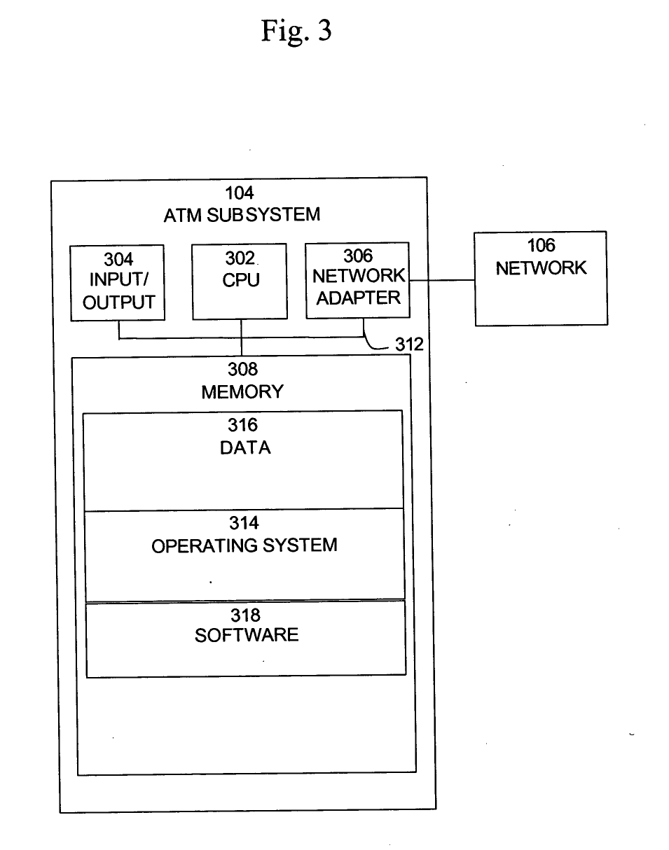

FIG. 3 is an exemplary block diagram of a representative Cash Dispensing subsystem 104 suitable for use in exemplary system 100 of FIG. 1. In FIG. 3, representative ATM subsystem 104 includes input/output device interface, and display interface 304 and network adapter 306, subsystem memory 308 and CPU 302. CPU 302 is connected by a bus 312 or other suitable interface means to subsystem memory 308, input/output device and display interface 304, and network adapter 306. CPU 302 executes program instructions in order to carry out the functions of the present invention.

Input/output device and display interface 304 provides the capability to input data to, or output data from Cash Dispensing subsystem 104. For example, input/output device interface 204 includes, but is not limited to, input devices such as a card readers, biometric readers, keypads, mice, touchpads, trackballs, output devices such as video, monitors, printers, cash dispenser, and input/output devices such as dialer/modems, and the like. Input/output device and display interface 304 enables input of customer identification information and check authorization codes and dispensing of cash. Network adapter 306 interfaces Cash Dispensing subsystem 104 with network 106.

Subsystem memory 308 stores program instructions that are executed by, and data that are used and processed by, CPU 302 to perform the functions of Cash Dispensing subsystem 104. Subsystem memory 308 can include electronic memory devices, such as random-access memory (RAM), read-only memory (ROM), programmable read-only memory (PROM), electrically erasable programmable read-only memory (EEPROM), flash memory, and electro-mechanical memory, such as magnetic disk drives, tape drives, optical disk drives, which can use an integrated drive electronics (IDE) interface, or a variation or enhancement thereof, such as enhanced IDE (EIDE) or ultra direct memory access (UDMA), or a small computer subsystem interface (SCSI) based interface, or a variation or enhancement thereof, such as fast-SCSI, wide-SCSI, fast and wide-SCSI, etc, or a fiber channel-arbitrated loop (FC-AL) interface.

In the illustrative embodiment of Cash Dispensing subsystem 104, subsystem memory 308 includes operating subsystem 314, data 316 and software 318. Operating subsystem 314 provides overall subsystem functionality. Data 316 can include customer identification information and a disbursement authorization code. Software 318 provides the functionality for receive customer identification information and an check authorization code, transmit a disbursement request including, but not limited to, the customer identification information and an authorization code employing network 106, receive cash disbursement notification and dispense cash.

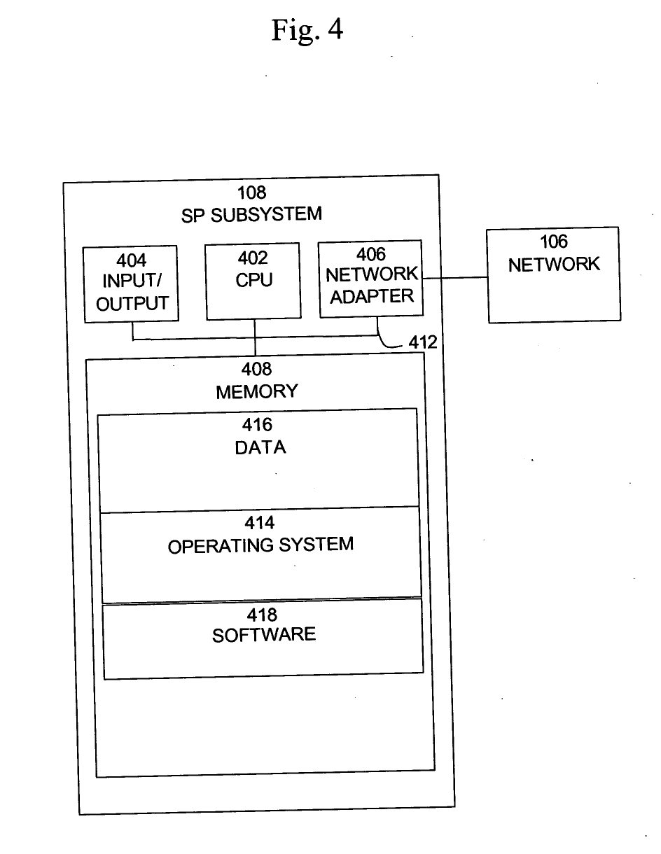

An exemplary block diagram of a representative SP subsystem 108 of FIG. 1 is provided in FIG. 4. In the illustrative embodiment of FIG. 4, SP subsystem 108 includes input/output device and display interface 404, network adapter 406, subsystem memory 408 and CPU 202. CPU 402 is connected by a bus 412 or other suitable interface means to subsystem memory 408, input/output device and display interface 404 and network adapter 406. CPU 402 executes program instructions in order to carry out the functions of the present invention.

Input/output device interface 404 provides the capability to input data to, or output data from subsystem 108. For example, input/output device and display interface 404 includes, but is not limited to, input devices such as a readers, biometric readers, keyboards, mice, touchpads, trackballs, output devices such as video, monitors, printers, and input/output devices such as dialer/modems, and the like. Input/output device and display interface 404 enables input of transaction information, verification requests, verification codes, time data and date data. Network adapter 206 interfaces subsystem 108 with network 102.

Subsystem memory 408 stores program instructions that are executed by, and data that are used and processed by, CPU 402 to perform the functions of subsystem 108. Subsystem memory 408 can include electronic memory devices, such as random-access memory (RAM), read-only memory (ROM), programmable read-only memory (PROM), electrically erasable programmable read-only memory (EEPROM), flash memory, and electro-mechanical memory, such as magnetic disk drives, tape drives, optical disk drives, which can use an integrated drive electronics (IDE) interface, or a variation or enhancement thereof, such as enhanced IDE (EIDE) or ultra direct memory access (UDMA), or a small computer subsystem interface (SCSI) based interface, or a variation or enhancement thereof, such as fast-SCSI, wide-SCSI, fast and wide-SCSI, etc, or a fiber channel-arbitrated loop (FC-AL) interface.

Illustrative subsystem memory 408 includes operating subsystem 414, data 416 and software 418. Operating subsystem 414 provides overall subsystem functionality. Data 416 can includes disbursement information, customer identification information, clerk identification information, a verification code, time data and date data. Software 418 provides the functionality for receiving disbursement transaction information, verification response, disbursement requests, processing the transaction information, verification responses and disbursement requests, transmitting verification request, funds disbursement notification and settlement notifications.

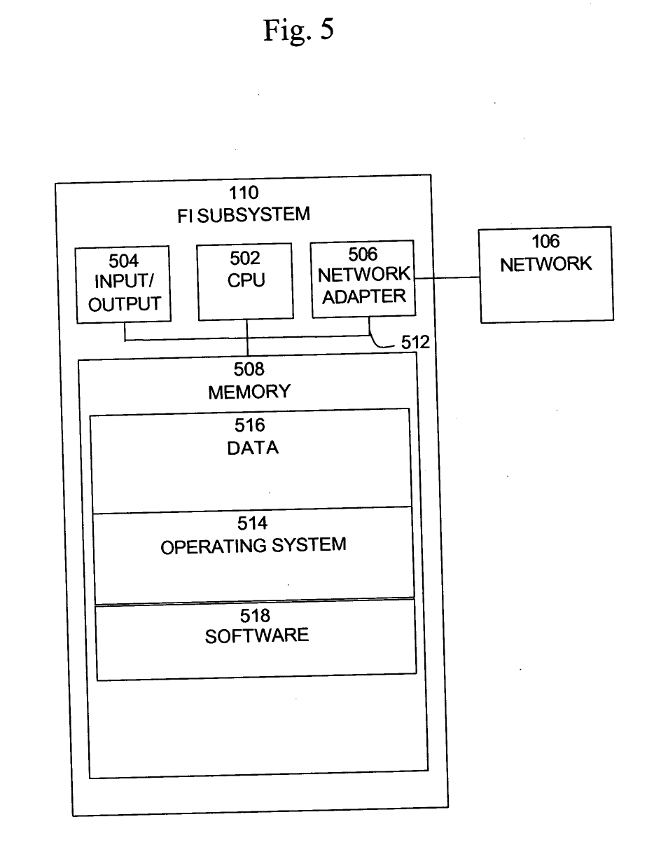

FIG. 5 is a block diagram of an illustrative embodiment of FI subsystem 110 of FIG. 1. In the FIG. 5, illustrative subsystem 110 includes input/output device interface and display interface 504, network adapter 506, subsystem memory 508 and CPU 202. CPU 502 is connected by a bus 512 or other suitable interface means to subsystem memory 508, input/output device and display interface 504 and network adapter 506. CPU 502 executes program instructions in order to carry out the functions of the present invention.

Input/output device and display interface 504 provides the capability to input data to, or output data from FI subsystem 110. For example, input/output device-display interface 504 includes, but is not limited to, input devices such as a readers, keyboards, mice, touchpads, trackballs, output devices such as video, monitors, printers, and input/output devices such as dialer/modems and the like. Input/output device and display interface 504 enables receipt of verification requests and settlement notification as well as transmission of verification responses. Network adapter 506 interfaces subsystem 110 with network 106.

Subsystem memory 508 stores program instructions that are executed by, and data that are used and processed by, CPU 502 to perform the functions of subsystem 110. Subsystem memory 508 can include electronic memory devices, such as random-access memory (RAM), read-only memory (ROM), programmable read-only memory (PROM), electrically erasable programmable read-only memory (EEPROM), flash memory, and electro-mechanical memory, such as magnetic disk drives, tape drives, optical disk drives, etc., which can use an integrated drive electronics (IDE) interface, or a variation or enhancement thereof, such as enhanced IDE (EIDE) or ultra direct memory access (UDMA), or a small computer subsystem interface (SCSI) based interface, or a variation or enhancement thereof, such as fast-SCSI, wide-SCSI, fast and wide-SCSI, or a fiber channel-arbitrated loop (FC-AL) interface.

Subsystem memory 508 includes operating subsystem 514, data 516 and software 518. Operating subsystem 514 provides overall subsystem functionality. The data 516 can include information related to funds available for disbursement, customer identification information, settlement files, and disbursement status information. Software 518 provides the functionality for receiving disbursement requests and settlement notifications, processing disbursement requests, including but not limited to, flagging information associated a disbursement as complete, transmitting verification responses, and creating a settlement files.

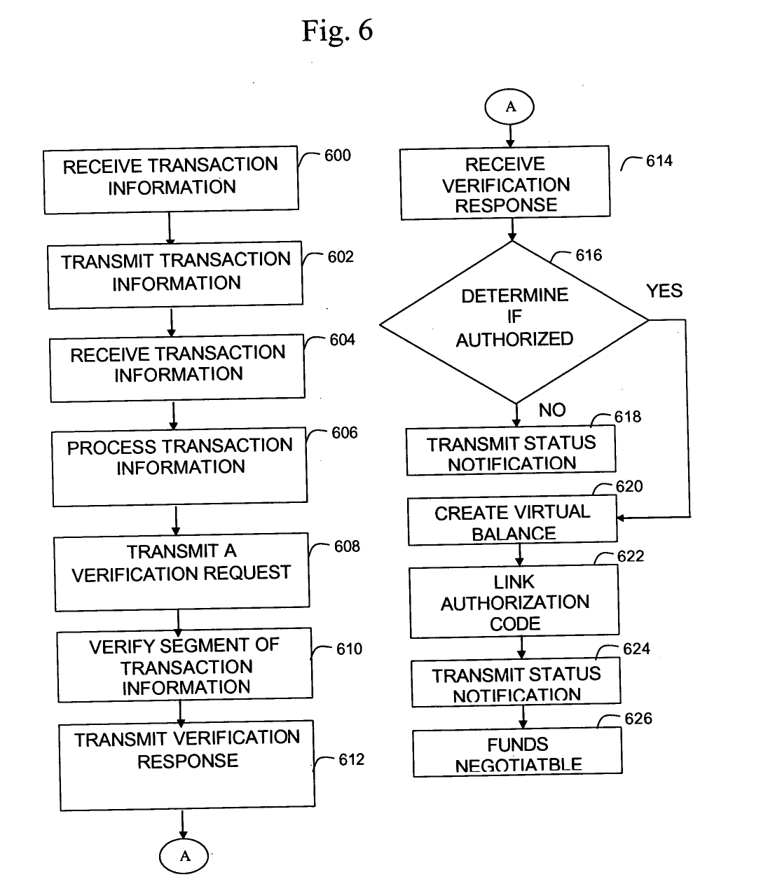

An exemplary flow diagram for a method of providing an interface for checkless cash disbursement according to the principles of present invention is shown in FIG. 6. In the FIG. 6 embodiment, the process begins with step 600. In step 600, checkless disbursement information is received by POS subsystem 102. In the FIG. 6 embodiment of the present invention, POS subsystem 102 is located, for example, at the site of a tax preparer's office offering real time loan origination or transfer request. The customer selects checkless disbursement over other method of funds disbursement. The checkless disbursement information includes, but is not limited to, a clerk PIN number and customer identification information. The customer identification information can include a PIN number selected by the customer, the customer's Social Security number, biometric data and challenge/champion information. At step 602, the transaction information is transmitted from the given POS subsystem 102 to a corresponding SP subsystem 108. Acceptance of a fee may be required prior to the transmission of the checkless transaction information to SP subsystem 108 to cover the cost of providing the service. The checkless transaction information is transmitted over the network 106.

At step 604, the checkless transaction information is received by corresponding SP subsystem 108 from POS subsystem 102. At step 606, the checkless transaction information is processed by SP subsystem 108. At step 608, a disbursement method notification request and collected customer information are transmitted to a corresponding FI subsystem 110 from SP subsystem 108. The particular FI subsystem 110 is the subsystem of the financial institution that may fund the loan or transfer the funds when available. The notification can be provided as a Universal Resource Locator (URL) applicable with an Active Server Page (ASP) model. SP Subsystem 108 and FI subsystem 110 are preferably directly linked through network 106.

At step 610, FI subsystem 110 verifies whether a segment of the notification information corresponds with customer information stored in the given FI subsystem 110. The segment of notification information includes, but is not limited to, customer's SSN.

At step 612, a verification response is transmitted to the corresponding SP subsystem 108 from the given FI subsystem 110. The verification response can be provided as an XML transaction message. The types of verification responses include, but are not limited to, successful notification, customer not found, name mismatch, invalid transaction, already settled, and try again later host unavailable.

At step 614, the verification response is received by SP subsystem 108 from FI subsystem 110. At step 616, it is determined whether the response specifies the notification as accepted. If the transaction is determined to be unauthorized the process proceeds to step 618.

At step 618, status notification information is transmitted from the SP subsystem 108 to the FI subsystem 102. The status notification indicates that the checkless disbursement has not been established and thus not negotiable using Cash Dispensing subsystem 104. If the transaction is determined to be authorized the process proceeds to step 620.

At step 620, upon approval of the loan or funding of the transfer, a balance is created by the financial institution. At step 622, the balance transmitted to SP subsystem 108 and is linked to the customer information. [At step 624, a status notification information is transmitted from the SP subsystem 108 to the POS subsystem 102.] The status notification indicates that funds are available, and thus, negotiable using a corresponding Cash Dispensing subsystem 104. At step 628, the given Cash Dispensing subsystem 104 funds disbursement transaction is performed.

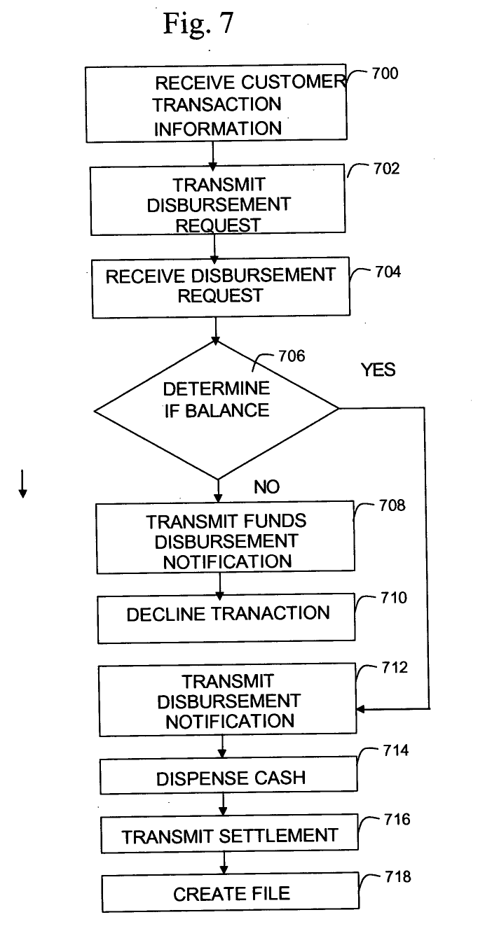

An exemplary flow diagram for a method of providing an interface for a given Cash Dispensing subsystem 104 funds disbursement transaction according to an embodiment of the present invention is shown in FIG. 7. In the illustrated embodiment of FIG. 7, the process begins with step 700. At step 700, customer information, including, but not limited to, biometric data, challenge/champion data and SSN is received by Cash Dispensing subsystem 104. The given Cash Dispensing subsystem 104 may be, for example, one that may be related to multiple POS subsystems 102. At step 702, a disbursement request is transmitted to an associated SP subsystem 108 from Cash Dispensing subsystem 104. The disbursement request includes, but is not limited to, the authorization code and customer identification information.

At step 704, the disbursement request is received by the SP subsystem 108 from the Cash Dispensing subsystem 104. At step 706, the disbursement request is processed by the SP subsystem 108. Processing the disbursement request includes, but is not limited to, determining whether there is a balance available to execute the request. If a balance is not determined to be available the process proceeds to step 708.

At step 708, a funds disbursement notification is transmitted from the SP subsystem 108 to the Cash Dispensing subsystem 104. The funds disbursement notification indicates that a balance is not available. At step 710, the disbursement transaction is declined. If a balance is determined to be available the process proceeds to step 712.

At step 712, a funds disbursement notification is transmitted from the SP subsystem 108 to the Cash Dispensing subsystem 104. The funds disbursement notification indicates the balance that is available in the virtual account to which the authorization code and customer information are linked. At step 714, cash dollars are dispensed from subsystem 104. At step 716, a disbursement transaction settlement notification is transmitted from SP subsystem 108 to FI subsystem 110. The transaction settlement notification includes, but is not limited to, the routing number and account number for a settlement account. At step 718, a settlement file is created for the transaction by FI subsystem 110 and transmitted to SP subsystem 108. It should be noted that, while the exemplary embodiments were discussed above with respect to RAL and RT transactions, the principles of the present invention are applicable to a wide range of financial transactions resulting in the availability of funds for distribution. One further example is the distribution of excess funds from an escrow account.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the true scope of the invention.

What is claimed is:

1. A method of providing checkless disbursement of cash due as funding from a financial transaction comprising:
receiving at an input terminal on a networked system a request for checkless disbursement of cash due as funding from a financial transaction, the request including information identifying a customer requesting the cash due;
determining with a processing subsystem on the networked system whether the disbursement request includes valid information; and
if the disbursement request includes valid information, making the cash due available for disbursement by a cash dispensing mechanism on the networked system.

2. The method of claim 1, wherein the funding comprises a refund.

3. The method of claim 1, wherein making the cash due available comprises making the cash due available as a refund anticipation loan.

4. The method of claim 1, wherein making the cash due available comprises making the cash due available as a refund transfer.

5. The method of claim 1, wherein determining if the disbursement request includes valid information comprises sending a verification request to a financial institution proposed for funding the cash disbursement.

6. The method of claim 1, wherein making the cash due available comprises creating a virtual account.

7. The method of claim 6, further comprising:
receiving a request for cash disbursement from a cash dispensing mechanism on the networked system;
determining with the processing subsystem on the networked system whether sufficient funds are available in the virtual account; and
if sufficient funds are available in the virtual account, sending a disbursement notification from the subsystem to the cash dispensing mechanism authorizing a disbursement.

8. The method of claim 6, wherein determining if the disbursement request includes valid information comprises sending decline information from financial institution proposed for funding the cash disbursement when the disbursement request includes invalid information.

9. The method claim 1, wherein determining whether the disbursement request includes valid information comprises:
receiving the customer information from the input terminal with a service provider subsystem;
processing the customer information with the service provider subsystem;
transmitting a verification request to a financial institution subsystem;
verifying the customer information with the financial institution subsystem;
in response to verifying the customer information, selectively transmitting an authorization to the service provider subsystem; and
creating a virtual balance accessible by the cash dispensing mechanism with the service provider subsystem in response to the authorization.

10. The method of claim 1, further comprising:
dispensing cash at a cash dispensing mechanism;
generating a settlement notification; and
transmitting the settlement notification to a financial institution funding the cash disbursement.

11. A software system for operating a networked system performing checkless disbursements of cash due as funding a financial transaction comprising:
processing a request for checkless disbursement of cash due as funding from a financial transaction, the request including information identifying a customer requesting the cash due;
determining whether the disbursement request includes valid information; and
if the disbursement request includes valid information, authorizing a checkless cash disbursement

12. The software system of claim 11, wherein the financial transaction comprises a loan.

13. The software system of claim 11, wherein the financial transaction comprises a funds transfer.

14. The computer program of claim 11, wherein the software system controls a networked system including:
an input terminal for receiving the request for checkless disbursement; and
at least one subsystem for determining if the request for checkless disbursement is valid and for authorizing a checkless disbursement.

15. The computer program of claim 16, wherein the software system further provides authorization to disburse cash to a cash disbursement terminal in response to a valid request for cash disbursement.

16. The computer program of claim 11, further operable to:
receive customer identification information from an input terminal and a service provider subsystem on the network;
process the customer information on the service provider subsystem;
transmit a verification request to a financial institution subsystem on the network of a financial institution proposing to fund the cash disbursement;
verify the customer information with the financial institution subsystem;
transmit an authorization to the service provider subsystem if the customer information is verified; and
create a virtual balance accessible by a cash dispensing terminal on the network with the service provider subsystem in response to the authorization.

17. The software system of claim 16, further operable to:
receive notification of a cash disbursement from the virtual balance from the service provider subsystem;
generating a settlement notification; and
transmitting the settlement notification to the financial institution.

18. A networked system for of providing checkless disbursement of cash due from a transaction comprising:
a terminal for receiving a request for checkless disbursement of cash due including information concerning the customer requesting the cash due;
a processing system operable to:
determine whether the disbursement request includes valid information; and
if the disbursement request includes valid information, making the cash due available for disbursement.

19. The networked system of claim 18, wherein the processing system comprises:
a service subsystem for processing the customer information in the disbursement request and generating a verification request and in response to a resulting authorization creating a virtual balance available for automated disbursement; and
a financial institution for processing the verification request and selectively generating the authorization upon verification of the customer information.

20. The networked system of claim 19, further comprising a cash dispensing mechanism for disbursing the virtual balance in response to a request by the customer.
